(19) United States
(12) Patent Application Publication
(10) Pub. No.: US 2024/0101905 A1
(43) Pub. Date: Mar. 28, 2024

(54) REACTIVE FLAME-PROOF COMPOSITION

(71) Applicant: SUNPOR KUNSTSTOFF GMBH, St. Pölten (AT)

(72) Inventors: Andreas MOSER, St. Pölten (AT); Gernot PEER, Wien (AT); Christian BUCHINGER, St. Georgen am Steinfelde (AT)

(21) Appl. No.: 18/272,710

(22) PCT Filed: Feb. 24, 2022
(86) PCT No.: PCT/EP2022/054634

§ 371 Date: Jul. 17, 2023

(30) Foreign Application Priority Data
Feb. 26, 2021 (DE) 10 2021 104 714.5

(51) Int. Cl. C09K 21/14; C08G 59/42; C08L 63/10

(52) U.S. Cl. CPC C09K 21/14; C08G 59/4223; C08L 63/10; C08L 2201/00

(57) ABSTRACT

The present disclosure relates to a reactive flame-proof composition for vinyl polymers, consisting at least of a first monomer and a second monomer that can be polymerised using the first monomer, wherein the first monomer has at least one aliphatic double bond and can be polymerised using the second monomer to form a reactive flame-proof polymer having an aliphatic double bond. The disclosure also relates to: a reactive flame-proof polymer produced by polymerisation of the reactive flame-proof composition; a use of the flame-proof composition and the flame-proof polymer; a flame-resistant vinyl polymer comprising the reactive flame-proof polymer; and methods for the production thereof. The subjects according to the disclosure can in particular advantageously reduce dripping of vinyl polymers during fires and can thus improve the flame-proof nature of such polymers.

### CROSS-REFERENCE TO RELATED APPLICATIONS

This application is a U.S. National Phase Application under 35 U.S.C. 371 of International Application No. PCT/EP2022/054634, filed on Feb. 24, 2022, which claims the benefit of German Patent Application No. 10 2021 104 714.5, filed on Feb. 26, 2021. The entire disclosure of the aforementioned German Patent Application is incorporated herein by reference.

### FIELD

The present disclosure relates to a reactive flame-proof composition for vinyl polymers, a reactive flame-proof polymer, a use of the flame-proof composition and the flame-proof polymer, methods for producing flame-proof vinyl polymers, and flame-proof vinyl polymers.

### BACKGROUND

This section provides background information related to the present disclosure which is not necessarily prior art.

Vinyl polymers are polymers of vinyl monomers obtained mostly by free-radical polymerization of the vinyl groups. Vinyl polymers find applications in numerous industrial fields. Of particular relevance is the vinyl polymer polystyrene, which is used in particular as an insulating material.

Polystyrene is a thermoplastic polymer made from styrene monomers, which is usually available as granules with a density of about 1050 kg/m³. Polystyrene granules are often further processed in a known manner for various applications. A distinction is made between expanded polystyrene (EPS) and extruded polystyrene (XPS) according to the processing method.

XPS is produced in a known manner by use of an extruder by melting the raw granulate and pressing the melt through a die, in particular with a blowing agent. In this case, the homogeneous material foams and can be removed from the process as a continuous part.

EPS is obtained in a known manner by expanding a raw granulate loaded with a blowing agent (for example with pentane) at temperatures above 90° C. Usually, in a first step, the granules are pre-expanded. In a second step, the pre-expanded granules are further expanded in a hollow mold. In this process, the expanded granulate particles fuse together to form a coherent molded body and form a particle foam.

XPS and EPS moldings are frequently used for thermal insulation or impact sound insulation or as precision-fit transport packaging for sensitive articles. EPS moldings are also used for special applications, such as helmets. In addition, such moldings can be used as positive patterns in metal casting processes.

Of importance for vinyl polymers is their fire behavior. For example, the regulations on the use of polystyrene particle foams as insulating materials for buildings in most cases require flame retardant properties. Particle foams, especially those made of expanded polystyrene, pose a particular challenge in this regard because they can soften and drip particularly easily in the case of fire, which can accelerate fire spread.

It is known to add flame-retardants to vinyl polymers in order to reduce the flammability of the polymers. However, known flame-retardants hardly influence the dripping behavior of the polymer during fires or often accelerate it, so that an important factor of the fire behavior of vinyl polymers has so far essentially remained unconsidered.

The flame retardancy of vinyl polymers therefore still offers potential for improvement. In particular, there may be potential for improvement in influencing the fire behavior per se and the dripping behavior in the case of fire.

### SUMMARY

This section provides a general summary of the disclosure, and is not a comprehensive disclosure of its full scope or all of its features.

It is therefore the object of the present disclosure to provide an improved flame retardancy for vinyl polymers, in particular by reducing the dripping behavior in the event of fire.

Preferred embodiments of the disclosure are provided in the subclaims, in the description or in the example, and further features described or shown in the subclaims or in the description or in the example may individually or in any combination constitute a subject matter of the disclosure unless the context clearly indicates otherwise.

The disclosure proposes a reactive flame-proof composition for vinyl polymers.

The reactive flame-proof composition comprises at least a first monomer and a second monomer polymerizable with the first monomer, wherein the first monomer comprises at least one aliphatic double bond and is polymerizable with the second monomer to form a reactive flame-proof polymer comprising an aliphatic double bond.

Here, a vinyl polymer is understood to mean a polymer of monomers which comprise a vinyl group, i.e. an ethene residue.

An aliphatic double bond is understood to mean a carbon-carbon double bond of an aliphatic hydrocarbon. In the sense of the present disclosure, an aromatic hydrocarbon, too, may comprise an aliphatic double bond if the carbon-carbon double bond is not part of the aromatic system.

In the sense of the present disclosure, an aliphatic double bond is also understood to mean a carbon-carbon double bond of a cycloaliphatic hydrocarbon, wherein the aliphatic double bond may also be provided within the ring structure of the cycloaliphatic hydrocarbon.

The term polymerizable is understood to mean that the first and the second monomer each have reactive groups capable of reacting with one another while forming a bond between the first and the second monomer, wherein an overall step-growth reaction can occur while forming an optionally branched polymer chain or a polymer network of interconnected first and second monomers.

The term reactive is understood in the sense of the present disclosure to mean that the flame-proof composition or the flame-proof polymer improves the flame retardancy and/or the dripping behavior of a polymer in a fire by a chemical reaction.

By means of the above-described reactive flame-proof composition, it can advantageously be achieved that vinyl polymers comprising such a reactive flame-proof composition exhibit improved fire retardant properties. Furthermore, by use of the reactive flame-proof composition described above it can be achieved that vinyl polymers comprising such a reactive flame-proof composition harden during a fire and flow less accordingly. In this way, it can advantageously be achieved that the vinyl polymer drips less during a fire, so that fire spread can greatly be reduced.

Without being bound by any theory, it is assumed that the reactive flame-proof composition present in a vinyl polymer at least in part as a reactive polymer, is capable of reacting with nascent vinyl radicals in the event of a fire, which may result from a reaction of the vinyl polymer and may comprise vinyl polymers, vinyl oligomers or vinyl monomers of the vinyl polymer. As a result, the vinyl radicals are bonded to form a duromer, which greatly increases the viscosity of the melt formed during a fire. Thus, dripping of the melt during fire can be greatly reduced and an improved fire protection can result.

In a preferred embodiment, it may be provided that the vinyl polymer is a particle foam.

In the sense of the present disclosure, a particle foam is understood to mean a polymer which is expandable or has been expanded from a granulate into a foam body.

In a preferred embodiment, it may be provided that the vinyl polymer is polyethylene, polypropylene, polystyrene, polyvinyl chloride, polyvinyl acetate or polyacrylonitrile, as well as a copolymer and/or a mixture thereof.

Preferably, it may be provided that the vinyl polymer is a polystyrene, particularly preferably expandable polystyrene (EPS).

In the sense of the present disclosure, polystyrene is also understood to mean copolymers of polystyrene, such as styrene-butadiene graft copolymers, styrene-butadiene block copolymers, styrene-acrylonitrile copolymers, acrylonitrile-butadiene-styrene copolymers and mixtures thereof.

For example, it may be provided that the polystyrene is selected from the group consisting of crystal clear polystyrene (GPPS), high-impact polystyrene (HIPS), anionically polymerized polystyrene or high-impact polystyrene (A-IPS), styrene-alpha-methylstyrene copolymer, acrylonitrile-butadiene-styrene polymerisate (ABS), styrene-acrylonitrile polymerisate (SAN), acrylonitrile-styrene-acrylic ester polymerisate (ASA), methyl acrylate-butadiene-styrene polymerisate (MBS), methyl methacrylate-acrylonitrile-butadiene-styrene polymerisate (MABS) or mixtures thereof, and optionally blended with polyphenylene ether (PPE) or polyphenylene sulfide (PPS).

Said polystyrene may have thermoplastic polymers in order to improve mechanical properties or temperature resistance, optionally using compatibilizers, such as polyamides (PA), polyolefins, such as polypropylene (PP) or polyethylene (PE), polyacrylates, such as polymethyl methacrylate (PMMA), polycarbonate (PC), polyester, such as polyethylene terephthalate (PET) or polybutylene terephthalate (PBT), polyether sulfones (PES), polyether ketones or polyether sulfides (PES), or mixtures thereof, generally in proportions in total of less than or equal to 30 wt.-%, preferably in the range of greater than or equal to 1 to less than or equal to 10 wt. %, based on the polystyrene.

Surprisingly, it could be shown that the reactive flame-proof composition is particularly suitable for the flame protection of polystyrene, since this drips particularly strongly in fires and the effect on the dripping behavior achieved by the reactive flame-proof composition is particularly pronounced in polystyrene.

Preferably, it may be provided that the first monomer is a monomer of the general formula (I):

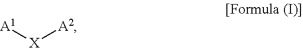

wherein *—X—* is a substituted or unsubstituted alkyl, a substituted or unsubstituted heteroalkyl, a substituted or unsubstituted aryl or a substituted or unsubstituted heteroaryl, wherein X comprises at least one aliphatic double bond,
wherein A¹ and A² are each, separately or combined, a polymerizable group, and
wherein the second monomer is a monomer of the general formula (II):

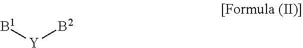

wherein *—Y—* is a substituted or unsubstituted alkyl, a substituted or unsubstituted heteroalkyl, a substituted or unsubstituted aryl, or a substituted or unsubstituted heteroaryl,
wherein B¹ and B² are each a group polymerizable with A¹ and A².

That A¹ and A² are each a polymerizable group separately or bonded to each other, means that A¹ and A² are respectively a polymerizable group or A¹ and A² are bonded to each other and form a group that can be split again into two groups, each of which is in turn polymerizable. For example, A¹ and A² may together form a carboxylic acid anhydride which can react with two monomers under cleavage.

Advantageously, the above-described reactive flame-proof composition can be particularly easily reacted in a vinyl polymer to form a corresponding reactive flame-proof polymer. In particular, thereby it can advantageously be achieved that the aliphatic double bond of the reactive flame-proof polymer corresponds to the aliphatic double bond of the first monomer. Advantageously, this allows the chemical properties of the aliphatic double bond of the reactive flame-proof polymer to be adjusted particularly easily.

Preferably, it may be provided that A¹ and A² each form a carboxylic acid, an alcohol or an amine, or A¹ and A² together form a carboxylic acid anhydride.

Surprisingly, it could be shown that such first monomers can be incorporated particularly well into vinyl polymers and polymerized with the second monomers to form the reactive flame-proof polymer therein.

Preferably, it may be provided that *—X—* is selected from the general formula (Ia), (Ib), (Ic) or (Id):

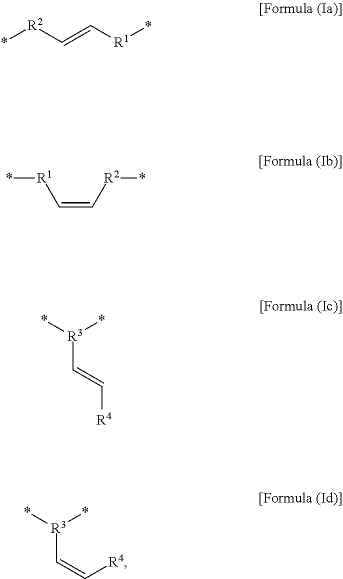

wherein R¹ and R² are independently selected from a single bond, a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl, and wherein R¹ and R² optionally form a cycle,
R³ is selected from a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl, and
R⁴ is selected from H, a halogen, a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl.

In this way, it can be achieved that the aliphatic double bond of a corresponding reactive flame-proof polymer has a particularly positive influence on the dripping properties of the vinyl polymer in case of a fire.

Preferably, it may be provided that B¹ and B² are each an epoxide, an alcohol, an amine, a carboxylic acid or an isocyanate.

Surprisingly, it could be shown that such second monomers can be incorporated particularly well into vinyl polymers and polymerized with the first monomers to form the reactive flame-proof polymer therein.

Preferably, it may be provided that A¹ and A² are a carboxylic acid and B¹ and B² are each an epoxide, an alcohol, or an amine; that A¹ and A² together form a carboxylic acid anhydride and B¹ and B² are each an epoxide, an alcohol, or an amine; that A¹ and A² are an alcohol and B¹ and B² are each a carboxylic acid; or that A¹ and A² are an amine and B1 and B² are each an epoxide or a carboxylic acid.

Advantageously, by use of the above combinations of first and second monomers it can be achieved that the reactive flame-proof composition can also be polymerized into the reactive flame-proof polymer in a vinyl polymer by particularly simple means and under mild conditions.

Preferably, it may be provided that A¹ and A² together form a carboxylic acid anhydride and B¹ and B² are each an epoxide.

In this way, it can be achieved that the reactive flame-proof composition can be mixed particularly well with the vinyl polymer and can be polymerized particularly easily to form the reactive flame-proof polymer. Furthermore, it can be achieved that the mechanical properties of the vinyl polymer are changed as little as possible. In addition, by use of the flame-proof composition described above a particularly good increase in the viscosity of the melt of the vinyl polymer in the event of a fire can be achieved, resulting in particularly improved flame-retardant properties.

In a preferred embodiment, it may be provided that B¹ and B² are an epoxide, and *—Y—* is a novolak.

In the sense of the present disclosure, novolaks are understood to mean low molecular weight phenolic resins which are obtained from phenols or phenolic derivatives, such as cresols, and formaldehyde and have a formaldehyde-phenol (derivative) ratio of less than 1:1.

In other words, it may preferably be provided that the second monomer is an epoxidized novolak, for example, an epoxyphenol novolak (EPN).

In this way, it can be achieved that the reactive flame-proof composition is particularly thermally stable.

In an alternative preferred embodiment, it may be provided that B¹ and B² are an epoxide, and *—Y—* has the general formula (IIa).

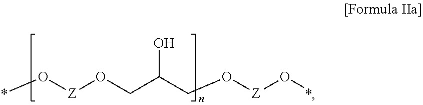

wherein Z is selected from a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl,
wherein n is an integer from greater than or equal to 0 to less than or equal to 60.

Thus, it can be achieved that the viscosity of the reactive flame-proof composition can be adjusted. In particular, with small n a low viscosity and thus, if necessary, a high reactivity of the second monomer can be achieved. In contrast, with large n, it can be achieved that the second monomer is a solid and the polymerization to the reactive flame-proof polymer must first be activated. In this way, a better control of the polymerization can be achieved.

Preferably, it may be provided that *—Z—* has the general formula (IIb):

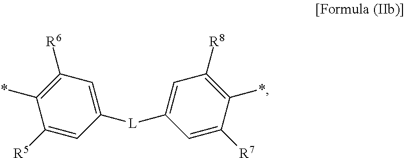

wherein R⁵, R⁶, R⁷ and R⁸ are independently H, a substituted or unsubstituted C1-C30 alkyl residue or Br, wherein preferably R⁵, R⁶, R⁷ and R⁸ are H or R⁵, R⁶, R⁷ and R⁸ are Br,
wherein *-L-* is selected from the following formulas (IIc) and (IId).

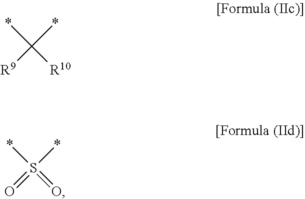

wherein R⁹ and R¹⁰ are independently H, methyl, ethyl, phenyl, or together cyclohexyl or fluorenyl.

In this way it can advantageously be achieved that the flame-retardant properties of the reactive flame-proof composition and the reactive flame-proof polymer obtained from the reactive flame-proof composition can be adjusted.

Preferably, it may be provided that *—B¹ and *—B² have the general formula (IIe):

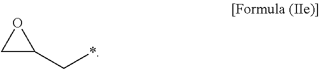

In this way it can advantageously be achieved that the second monomer is polymerized particularly easily with the first monomer.

Preferably, it may be provided that the second monomer is an epoxy resin, for example a brominated epoxy resin, wherein in one embodiment the second monomer is a brominated epoxy resin having the following formula

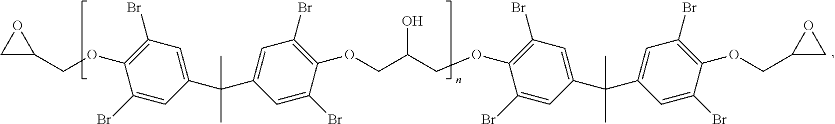

wherein n is an integer from greater than or equal to 0 to less than or equal to 60.

In this way it can advantageously be achieved that the second monomer can be polymerized particularly easily with the first monomer and, in addition to increasing the viscosity of the melt of the vinyl polymer provided with the corresponding reactive flame-proof polymer, an additional flame retardancy can be achieved by producing bromine-containing gases during the combustion.

Preferably, it may be provided that the first monomer is selected from substituted or unsubstituted tetrahydrophthalic anhydride and maleic anhydride, wherein the first monomer is, for example, tetrahydrophthalic anhydride having the following formula:

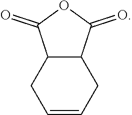 [SMILES: O=C1OC(=O)C2CC=CCC12]

It could be shown that such first monomers are particularly well suited to increase particularly strongly the viscosity of the melt of a corresponding vinyl polymer during a fire. Without being bound by any theory, it is assumed that the aliphatic double bond of such monomers allow the aliphatic double bond to remain particularly reactive for vinyl radicals even in the corresponding reactive flame-proof polymer.

In an alternative preferred embodiment, it may be provided that the first monomer is a diene, preferably selected from butadiene, isoprene and mixtures thereof, and the second monomer comprises a vinyl group, wherein the second monomer preferably is selected from styrene, ethylene, propylene and mixtures thereof.

Surprisingly, it could be shown that a reactive flame-proof polymer can also be obtained by the first and the second monomer described above, which polymer can increase the viscosity of the melt during a fire of a vinyl polymer comprising the reactive flame-proof polymer, and thus can positively affect the dripping and fire properties.

Preferably, it may be provided that the reactive flame-proof composition comprises a polymerization catalyst capable of catalyzing the polymerization between the first monomer and the second monomer.

In this way, it can be achieved that the polymerization of the reactive flame-proof composition to the reactive flame-proof polymer can proceed well even when blended in a vinyl polymer.

Preferably, it may be provided that the reactive flame-proof composition comprises the polymerization catalyst in an amount of greater than or equal to 0.1 wt. % to less than or equal to 20 wt.-% based on the reactive flame-proof composition, preferably from greater than or equal to 1 wt.-% to less than or equal to 5 wt.-%, particularly preferably of 2 wt.-%.

In this way, it can be achieved that the polymerization of the reactive flame-proof composition can be well controlled and, at the same time, the flame-proof polymer obtained is not excessively contaminated by remaining catalyst.

Preferably, it may be provided that A¹ and A² together form a carboxylic acid anhydride, B¹ and B² are each an epoxide, and the polymerization catalyst is an N-based catalyst, preferably an imidazole, particularly preferably isopropyl imidazole.

Surprisingly, it could be shown that such catalysts are particularly well suited for the polymerization of such monomers, especially also when the reactive flame-proof composition is already incorporated into a vinyl polymer and is to be polymerized to the reactive flame-proof polymer.

Preferably, it can be provided that the molar ratio of the reactive groups of the first monomer to the second monomer is greater than or equal to 1:5 to less than or equal to 5:1, preferably greater than or equal to 1:2 to less than or equal to 2:1, more preferably greater than or equal to 1:1.1 to less than or equal to 1.1:1, particularly preferably 1:1.

In this way, it can be achieved that the degree of polymerization of the reactive flame-proof polymer obtained from the reactive flame-proof composition can be adjusted.

The disclosure further proposes a reactive flame-proof polymer. The reactive flame-proof polymer is produced by polymerizing the reactive flame-proof composition described above, wherein the reactive flame-proof polymer has an aliphatic double bond.

Without being bound by any theory, it is assumed that the reactive flame-proof polymer incorporated in a vinyl polymer can react with nascent vinyl radicals in the case of fire of the same. As a result, the vinyl radicals are bonded to form a duromer, which greatly increases the viscosity of the melt formed during the fire. Thus, dripping of the melt during fire can be greatly reduced and an improved fire protection can be achieved.

In a preferred embodiment, it can be provided that the reactive flame-proof polymer is an epoxy resin crosslinked with tetrahydrophthalic anhydride, for example a brominated epoxy resin crosslinked with tetrahydrophthalic anhydride.

In this way, it can be achieved that the dripping behavior of the vinyl polymer can be particularly well improved in the event of a fire, and the flame-proof polymer can be incorporated into the vinyl polymer particularly easily.

In an alternative preferred embodiment, it may be provided that the reactive flame-proof polymer is a styrene-butadiene-styrene (SBS) block copolymer, a styrene-isoprene-styrene (SIS) block copolymer, a rubber-modified polystyrene (high-impact polystyrene; HIPS) or an ethylene-propylene-diene rubber.

In this way, it can advantageously be achieved that the reactive flame-proof polymer has particularly little adverse effect on the mechanical properties of the vinyl polymer.

The reactive flame-proof composition for vinyl polymers described above and the reactive flame-proof polymer described above thus each serve to provide an improved flame protection for vinyl polymers.

The disclosure thus also proposes the use of a reactive flame-proof composition previously described as a flame protection for vinyl polymers and products made therefrom, and the use of a previously described reactive flame-proof polymer as a flame protection for vinyl polymers and products made therefrom.

The disclosure further proposes a method for producing a flame-proof vinyl polymer.

In one embodiment of the method, a vinyl polymer is blended with the aforementioned reactive flame-proof composition under energy input, wherein the reactive flame-proof composition at least partially polymerizes to form the reactive flame-proof polymer comprising an aliphatic double bond.

The reactive flame-proof polymer is thus first obtained in the vinyl polymer from the reactive flame-proof composition.

In this way, it can advantageously be achieved that the reactive flame-proof polymer is particularly homogeneously distributed in the vinyl polymer, especially in comparison with commercially available unsaturated polymers. Furthermore, it can be advantageously achieved that also reactive flame-proof polymers with mechanical properties can be homogeneously incorporated into the vinyl polymer, which differ significantly from those of the vinyl polymer. For example, reactive flame-proof polymers with a significantly higher hardness or higher melting point can be readily incorporated into the vinyl polymer because blending is realized with the reactive flame-proof composition, which may have different mechanical properties than the reactive flame-proof polymer.

In an alternative embodiment of the method, a vinyl polymer is blended with the reactive flame-proof polymer described above.

Thus, the reactive flame-proof polymer is incorporated directly into the vinyl polymer.

In this way, it can advantageously be achieved that blending can be carried out particularly easily. In particular, in the production according to this method, no care must be taken during blending to realize an energy input by which the polymerization of the reactive flame-proof composition is driven.

Preferably, it may be provided that the vinyl polymer is blended with an reactive flame-proof composition or an reactive flame-proof polymer in an amount, based on the vinyl polymer, of greater than or equal to 1 wt.-% to less than or equal to 20 wt.-%, preferably greater than or equal to 3 wt.-% to less than or equal to 7 wt.-%, more preferably of 5 wt.-%.

It could be shown that with a reactive flame-proof composition or a reactive flame-proof polymer in this amount, a significant improvement in the fire properties of the vinyl polymer can be achieved without impairing the mechanical properties of the vinyl polymer too much.

Preferably, it may be provided that the vinyl polymer and the reactive flame-proof composition or the reactive flame-proof polymer are blended with an extruder, in particular with a twin-screw extruder, wherein preferably a polymer melt formed in this process is conveyed through a die plate and is pelletized with a pressurized underwater granulator.

In this way, it can advantageously be achieved that the reactive flame-proof composition can be easily polymerized and/or the reactive flame-proof polymer can be homogeneously distributed in the vinyl polymer. By use of the proposed extruders it can be achieved that the method can be particularly easily controlled. Furthermore, it can optionally be achieved that a homogeneous granulate is obtained. For example, a polystyrene granulate can be obtained by the method described above, if the vinyl polymer is polystyrene, in particular an expandable polystyrene granulate, if a blowing agent is added to the vinyl polymer or polystyrene.

Preferably, it can be provided that a blowing agent is added to the vinyl polymer and the reactive flame-proof composition or the reactive flame-proof polymer in the extruder. Particularly preferably, the blowing agent is metered in an amount of greater than or equal to 2 wt.-% to less than or equal to 10 wt.-%, based on the sum of the masses of the vinyl polymer, the reactive flame-proof composition or the reactive flame-proof polymer and the blowing agent. The blowing agent can preferably be an aliphatic hydrocarbon comprising 2 to 7 carbon atoms, an alcohol, a ketone, an ether or a halogenated hydrocarbon. Particularly preferably, the blowing agent may be isobutane, n-butane, iso-pentane or n-pentane. Most preferably, the blowing agent may be n-pentane.

Furthermore, additives, nucleating agents, fillers, plasticizers, soluble and insoluble inorganic and/or organic dyes and pigments, e.g. IR absorbers such as carbon black, graphite or aluminum powder, can be added to the vinyl polymer in the extruder together or spatially separated, e.g. via mixers or side extruders. As a rule, the dyes and pigments are added in amounts in the range of 0.01 to 30 wt.-%, based on the vinyl polymer, preferably in the range of 1 to 10 wt.-%. For homogeneous and microdisperse distribution of the pigments in the vinyl polymer, it may be useful, in particular in the case of polar pigments, to use a dispersing aid, e.g. organosilanes, polymers containing epoxy groups or maleic anhydride-grafted styrene polymers. Preferred plasticizers are mineral oils, phthalates, which can be used in amounts of 0.05 to 10 wt.-%, based on the vinyl polymer.

The disclosure further proposes a flame-proof vinyl polymer. Here, the flame-proof vinyl polymer was produced by the method described above, wherein the vinyl polymer comprises the reactive flame-proof polymer described above and optionally comprises an additional flame retardant.

Here, the flame-proof vinyl polymer described above can advantageously exhibit an improved dripping behavior in the case of a fire compared to known flame-proof vinyl polymers.

Here, an additional flame retardant may further improve the flame-proof properties of the flame-proof vinyl polymer in a known manner. For example, the additional flame retardant may be brominated styrene-butadiene copolymer.

The disclosure further proposes a flame-proof polystyrene granulate. The flame-proof polystyrene granulate was produced as described above, wherein the vinyl polymer is polystyrene, and comprises the reactive flame-proof polymer described above and optionally an additional flame retardant.

Here, the flame-proof polystyrene granules described above can advantageously exhibit an improved dripping behavior in the case of a fire compared to known flame-proof polystyrene granules.

Particularly preferably, it can be provided that the flame-proof polystyrene granulate is flame-proof expandable polystyrene granulate, wherein a blowing agent has been added to the vinyl polymer or polystyrene and the reactive flame-proof composition or the reactive flame-proof polymer in the extruder.

The disclosure further proposes a molded article of expanded flame-proof polystyrene granulate, wherein the molded article has been produced with the aforementioned flame-proof polystyrene granulate, in particular with the flame-proof expandable polystyrene granulate.

The disclosure is further explained below with reference to an example.

### EXAMPLE 1

A styrenic polymer (SUNPOR EPS-SE: 6 wt.-% pentane, chain length Mw=200,000 g/mol, dispersity Mw/Mn 2.5) was admixed in the feed section of a twin screw extruder with a reactive flame-proof composition consisting of 4 wt.-% brominated epoxy resin (ICL IP F2200WV1) as the second monomer, 1 wt.-% tetrahydrophthalic anhydride (THPA) as the first polymer and 0.1 wt.-% isopropylimidazole as the polymerization catalyst, based on the total amount of the EPS granulate obtained. The mixture was melted in the extruder at 170° C. The resulting polymer melt obtained in this way was conveyed at a flow rate of 15 kg/h through a die plate and granulated into compact EPS granulate by use of a pressurized underwater granulator.

The thus obtained resulting EPS granulates exhibited improved flame retardancy and drainage properties compared to EPS granulates produced without reactive flame-proof composition.

### REFERENCE EXAMPLE 1

Analogous to Example 1, additives were added in the feed section of a twin-screw extruder which, in contrast to the subject matter of the disclosure, are not polymerizable to a reactive flame-proof polymer comprising an aliphatic double bond and do not form a flame-proof composition in the sense of the present disclosure. In order to generate this property, 1 wt.-% phthalic anhydride (PA) was used instead of THPA as the first polymer, which, in contrast to tetrahydrophthalic anhydride (THPA), does not include an aliphatic double bond. As the second monomer, again 4 wt.-% F2200HM was used and as polymerization catalyst also 0.1 wt.-% isopropylimidazole, based on the total amount of EPS granules obtained.

### Simulation of a Fire of a House Facade

In order to simulate the actual conditions of an EPS insulation layer behind a facade front in case of fire, the produced EPS granulates from Example 1, Reference Example 1 and a commercially available EPS granulate (Sunpor LP 750) were melted directly on a hot plate at 2 different temperatures. Temperatures of 240° C. and 280° C. were selected and respectively 2 g of the EPS granulate was melted for 5 min (measured after obtaining a homogeneous melt). The samples treated in this way were subsequently further investigated. Without being bound to any theory, it can be assumed that the polystyrene radicals formed at these temperatures react with the aliphatic double bonds of the compositions according to the disclosure and counteract the trickling of the decomposing thermoplastic with an increase in viscosity, which cannot be achieved by compositions not according to the disclosure.

### Rheometry Tests in Oscillation Mode

The melts of the EPS granulates from example 1, the commercial product and reference example 1 (partially) decomposed according to the process described above were measured by means of oscillatory rheometry in order to determine differences in viscosity and network properties thereof. For this purpose, a TA Instruments HR 20 rheometer was used with a 25 mm plate-plate system with 1 mm gap spacing at 180° C. The displacement during the measurement was 1% and measurements were made in the shear rate range from 0.01 Hz to 100 Hz. Table 1 shows the dynamic viscosity (η) at 1 Hz and the frequency intersection point (F_{S}) of the storage modulus and the loss modulus.

TABLE 1
Results of oscillatory rheometry

| | Melting temperature | | | |
|---|---|---|---|---|
| | 240° C. | | 280° C. | |
| | η_{1 Hz} [Pa s] | F_{S} [Hz] | η_{1 Hz} [Pa s] | F_{S} [Hz] |
| Commercial product | 3203 | 7.9 | 941 | 100 |
| Example 1 | 4502 | 3.1 | 1162 | 50.1 |
| Reference example | 3278 | 5.0 | 484 | >100* |

*Frequency intersection point already outside the measuring range

Table 1 shows a clear influence of the subject matter according to the disclosure on both the dynamic viscosity and the frequency intersection point. While at 240° C. melting temperature, the viscosity of Example 1 is already ˜40% higher, the difference at 280° C. melting temperature is particularly evident compared to the reference example without polymerizable double bond. Here, the increase of Example 1 is already 240%, while an increase in viscosity of 24% is also recognizable compared to the commercial product.

The frequency intersection point of storage modulus and loss modulus is a measure for the molecular mobility at a specified temperature. While an entirely continuous network such as in duromers results in that even at lowest frequencies and all temperatures the storage modulus is above the loss modulus, at thermoplasts there is a strong dependency on the temperature, the molecular weight and optional proportions of gel. Thus, the frequency intersection point is a good measure for the efficiency of the subject matter according to the disclosure.

Table 1 shows, that example 1 both at 240° C. and at 280° C. melting temperature has a significantly lower frequency intersection point than the commercial product and the reference example. This clearly shows, that the molecular mobility is significantly restricted and a reaction in the simulated case of a fire has occurred.

The flame-proof compositions according to the disclosure thus show improved flow-off properties in the case of a fire for vinyl polymers, in particular also with respect to compositions, which only differ from the compositions according to the disclosure in that the first monomer comprises no aliphatic double bond.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A reactive flame-proof composition for vinyl polymers comprising at least a first monomer and a second monomer which is polymerizable with the first polymer,
wherein
the first monomer comprises at least one aliphatic double bond and is polymerizable with the second monomer to a reactive flame-proof polymer comprising an aliphatic double bond.

2. The reactive flame-proof composition according to claim 1, wherein the first monomer is a monomer of the general formula (I): 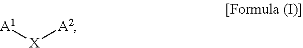
wherein *—X—* is a substituted or unsubstituted alkyl, a substituted or unsubstituted heteroalkyl, a substituted or unsubstituted aryl or a substituted or unsubstituted heteroaryl, wherein X comprises at least one aliphatic double bond,
wherein A¹ and A² are each, separately or combined, a polymerizable group, and
wherein the second monomer is a monomer of the general formula (II): 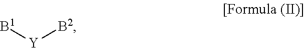
wherein *—Y—* is a substituted or unsubstituted alkyl, a substituted or unsubstituted heteroalkyl, a substituted or unsubstituted aryl, or a substituted or unsubstituted heteroaryl,
wherein B¹ and B² are each a group polymerizable with A¹ and A².

3. The reactive flame-proof composition according to claim 2, wherein
*—X—* is selected from the general formula (Ia), (Ib), (IC) or (Id): 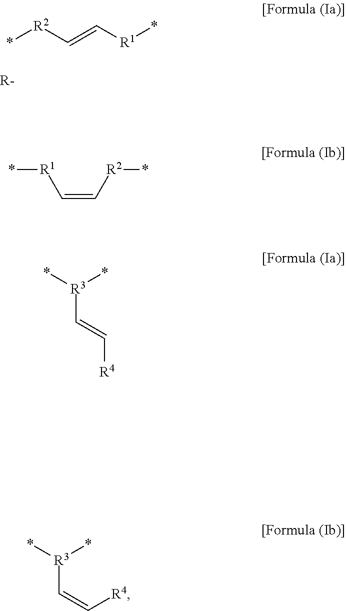
wherein R¹ and R² are independently selected from a single bond, a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl, and wherein R¹ and R² optionally form a cycle,
R³ is selected from a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl, and
R⁴ is selected from H, a halogen, a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl.

4. The reactive flame-proof composition according to claim 2, wherein B¹ and B² are an epoxide, and *—Y—* has the general formula (IIa): 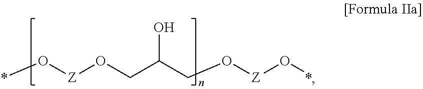
wherein Z is selected from a substituted or unsubstituted C1-C30 alkyl, a substituted or unsubstituted C1-C30 heteroalkyl, a substituted or unsubstituted C6-C24 aryl, and a substituted or unsubstituted C6-C24 heteroaryl,
wherein n is an integer from greater than or equal to 0 to less than or equal to 60.

5. The reactive flame-proof composition according to claim 4, wherein
*—Z—* has the general formula (IIb) 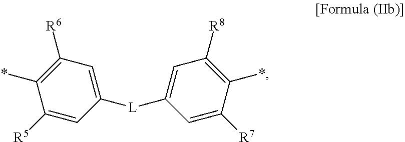
wherein R⁵, R⁶, R⁷ and R⁸ are independently H, a substituted or unsubstituted C1-C30 alkyl residue or Br, wherein preferably R⁵, R⁶, R⁷ and R⁸ are H or R⁵, R⁶, R⁷ and R⁸ are Br, wherein *-L-* is selected from the following formulas (IIc) and (IId). 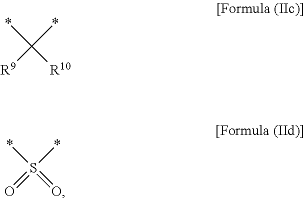
wherein R⁹ and R¹⁰ are independently H, methyl, ethyl, phenyl, or together cyclohexyl or fluorenyl.

6. The reactive flame-proof composition according to claim 1, wherein the first monomer is selected from substituted or unsubstituted tetrahydrophthalic anhydride and maleic anhydride, wherein the first monomer is preferably tetrahydrophthalic anhydride having the formula

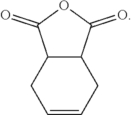 [SMILES: O=C1OC(=O)C2CC=CCC12]

7. A reactive flame-proof polymer produced by polymerization of the reactive flame-proof composition according to claim 1, wherein the reactive flame-proof polymer comprises an aliphatic double bond.

8. The reactive flame-proof composition according to claim 1, wherein the reactive flame-proof composition comprises a as flame retardant for a vinyl polymer and/or a flame retardant for a product produced from the vinyl polymer.

9. A method for producing a flame-proof vinyl polymer wherein a vinyl polymer is blended with the reactive flame-proof composition according to claim 1 under energy input, wherein the reactive flame-proof composition at least partially polymerizes while forming the reactive flame-proof polymer comprising an aliphatic double bond.

10. A method for producing a flame-proof vinyl polymer wherein a vinyl polymer is blended with the reactive flame-proof polymer according to claim 7.

11. A flame-proof vinyl polymer produced according to the method of claim 9, wherein the vinyl polymer comprises the reactive flame-proof polymer according to claim 7 and optionally comprises an additional flame retardant.

12. The reactive flame-proof polymer according to claim 7, wherein the reactive flame-proof polymer comprises a flame retardant for a vinyl polymer and/or a flame retardant for a product produced from the vinyl polymer.

13. A flame-proof vinyl polymer produced according to the method of claim 10, wherein the vinyl polymer comprises the reactive flame-proof polymer according to claim 7 and optionally comprises an additional flame retardant.
